(19) United States
(12) Patent Application Publication
(10) Pub. No.: US 2025/0326087 A1
(43) Pub. Date: Oct. 23, 2025

(54) SURFACE TREATMENT METHOD FOR STRUCTURE, BLAST TREATMENT APPARATUS, DEPOSIT REMOVAL METHOD AND APPARATUS INCORPORATED IN MANUFACTURING FACILITY FOR PRODUCING PARTICULATE PRODUCT, AND MANUFACTURING METHOD AND FACILITY FOR PRODUCING PARTICULATE PRODUCT

(71) Applicant: GRANDLINE Inc., Otsu-shi, Shiga (JP)

(72) Inventor: Satoru HAYAKAWA, Otsu-shi (JP)

(21) Appl. No.: 18/717,637

(22) PCT Filed: Dec. 16, 2022
(86) PCT No.: PCT/JP2022/046374

§ 371 Date: Nov. 12, 2024

(30) Foreign Application Priority Data
Dec. 20, 2021 (JP) 2021-205877
Sep. 15, 2022 (JP) 2022-146888

(51) Int. Cl. B24C 1/08; B05B 1/04; B24C 5/04; B24C 11/00

(52) U.S. Cl. CPC B24C 1/086; B05B 1/04; B24C 5/04; B24C 11/00

(57) ABSTRACT

The method employs blast media containing a first grainy material, consisting mainly of a material with a hardness equal to or less than that of the target member to be restored in granular form. This blast media, along with gas, is ejected from a nozzle with a substantially rectangular-shaped outlet, while adjusting the flow rate. The ejected mixture functions as a graining tool to remove pollution, exposing underlying or surrounding surface to be restored of the target member without grinding away the surface and simultaneously providing a rough treatment to form fine texture on the restored surface.

### TECHNICAL FIELD

The present invention relates to a surface treatment method of a member of a structure for removing pollution from a surface of the member polluted by the pollution or deteriorated to restore the member, and relates to a blast treatment apparatus used for surface treatment of a structure. Furthermore, the present invention relates to a cleaning aimed method and apparatus for removing a particulate deposit adhered to an equipment used in a manufacturing facility of a particulate product such as sugar, as well as to a method and a manufacturing facility for manufacturing the particulate product using said method and apparatus.

### BACKGROUND ART

A surface of a member of a structure such as an outdoor building, deteriorates and become polluted while it has been exposed to wind, rain, dust, sunlight, and so on. When a surface of a member of a structure becomes polluted, a cleaning process is conducted to remove the pollution to restore the surface of the member. A blast treatment method blasting fluid such as water with a high-pressure and high-speed onto the surface of the member is known as the cleaning process. Blast treatment methods can be classified into dry blast treatment, which uses a gas such as air as the driving fluid to eject abrasive particles (blast media) to polish the pollution (for example, see Patent Document 1), and wet blast treatment, which uses a liquid such as water as the driving fluid (for example, see Patent Documents 2 and 3).

In addition, a surface of a member of an indoor structure may also become polluted. For example, some kinds of structures such as a manufacturing facility installed indoors in a factory can be polluted by a substance like a manufactured product adhered to the surface of the member incorporated in the facility during its operation.

For example, an equipment of a manufacturing facility for manufacturing a grainy material (a particulate product) may become polluted by the particulate product being deposited.

To illustrate, take sugar as an example of a particulate product. Sugar can be broadly classified into refined sugar and unrefined sugar. A manufacturing method of refined sugar is disclosed in Patent Document 4. According to this literature, raw sugar (raw material sugar) is produced from harvested sugarcane or sugar beets, and this raw sugar is washed, purified, crystallized, etc., within the factory to be refined into sugar. The finished sugar is stored in different silos depending on the product.

By the way, in a sugar refinery, finished sugar is transferred vertically or horizontally using elevators or vibrating conveyors consisting of buckets and chains to be stored in silos or so. Sugar adheres to the drive components of these elevators and conveyors. However, when sugar adheres to the drive components, it becomes firmly attached by rubbing at high pressure at the sliding parts of the drive components, and the attached sugar is discolored by heat due to a browning reaction through further friction. It is undesirable for this discolored sugar to be mixed into the product.

Therefore, a sugar removal treatment has been periodically conducted to remove sugar adhered to the drive components in the conventional method. Specifically, a targeted drive component is removed from the facility and immersed in hot water to melt and remove the adhered sugar. The solution in which the sugar has melted is heated to evaporate the water, precipitating the sugar, which is then reused as sugar to be refined.

### RELATED DOCUMENTS

### Patent Documents

[Patent Document 1] Japanese Registered Publication No. 7025770

[Patent Document 2] Japanese Registered Publication No. 6963261

[Patent Document 3] Japanese Unexamined Patent Publication No. 2018-75706

[Patent Document 4] Japanese Unexamined Patent Publication No. 2003-61700

### SUMMARY OF INVENTION

### Technical Problem

While cleaning an outdoor structure using blast treatment, there are several problems. For example, treatment conditions should be optimized depending on the target or purpose of the treatment when conducting the blast treatment for cleaning, which requires complex deliberation. For instance, there are various kinds of blast media used in blast treatments, as well as various kinds and conditions of driving fluid used for blasting the media. There is correlation between the kinds of blast media and the kinds of driving fluid, as well as the conditions for blasting, and there is suitability in their combinations. Furthermore, when selecting the types of blast media and driving fluid, as well as the conditions for blasting, factors such as the treatment purpose, site environment, and characteristics of the target object must also be taken into consideration. Thus, to obtain the optimal conditions of blast treatment, it is necessary to consider various parameters.

However, determining optimal treatment conditions by considering all these various parameters can be a very intricate task. Therefore, versatile conditions to be applicable to a certain range of parameters are chosen in general. For instance, a treatment condition with slightly higher (or lower) capabilities for removing pollution is selected to be applicable to multiple types of target objects with similar characteristics. However, by selecting a treatment condition with such versatility, there may be instances where the ability to remove pollution is excessive or inadequate depending on the target object, which can affect the operability on-site.

In the case of a blast treatment for cleaning a surface of a member of a delicate structure such as cultural properties like temples and shrines, which is generally of high value and require careful treatment, it may be necessary to remove pollution while avoiding damage to the target member and the surrounding areas. Moreover, there are cases where it is required to remove pollution while preserving historical valuable parts such as blade marks and carvings (referred to as “gouges”). In such cases, it has been difficult to perform delicate operations, such as removing pollution on a fine texture (for example, on the order of millimeters or less) formed on a surface of a member with general blast treatment. In other words, performing delicate operations such as removing pollution on a fine texture such as gouges, while maintaining the fine texture on the surface of the member has been difficult.

Regarding to the sugar removal treatment mentioned as the cleaning of an indoor structure, there are several problems. Namely, the sugar removal treatment requires to remove drive components as mentioned above, so it is quite labor-intensive. Additionally, the process of heating the solution in which sugar has melted to precipitate the sugar entails both significant labor and energy consumption, resulting in high costs. Furthermore, parts come into direct contact with each other at the sliding areas of the drive components right after the sugar removal treatment as described above. This makes risks of metal particles chipping off from the sliding areas and contaminating the product. Therefore, it is necessary to perform an additional treatment called “cover,” dusting grainy sugar onto the sliding areas of the drive components which makes the conventional sugar removal treatment complicated. Such problems exist in the cleaning of equipment used not only in the production of refined sugar but also in the production of unrefined sugar. Additionally, similar problems exist not only in sugar manufacturing facilities but also in salt manufacturing facilities when removing salt adhered to components, as well as in various manufacturing facilities for a wide range of particulate products.

Therefore, the present disclosure aims to solve at least one of the aforementioned problems. Specifically, it provides a surface treatment method for a structure and a blast treatment apparatus, which enables the easy determination of the treatment condition for cleaning a structure with a blast treatment. Additionally, it aims to provide a deposit removal method and apparatus capable of easily removing a particulate material adhered to components used in facility for manufacturing the particulate product, as well as a manufacturing method and apparatus for manufacturing the particulate product incorporating these.

### Solution to Problem

A first aspect of a surface treatment method of the present disclosure is a surface treatment method for a structure, which removes pollution from an exposed surface of a member of the structure to restore the member, using:
a blast media containing a first grainy material as a main component, where the hardness of the material is equal to or less than the hardness of the member, and
a blast treatment apparatus having a nozzle for blasting the blast media onto the surface of the member using a gas as a driving fluid, a hollow tube for delivering a mixture of the blast media and the gas to the nozzle, and a discharge control unit for adjusting the flow rate of the mixture supplied from the hollow tube to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment adjusting the flow rate of the mixture while the surface of the member is exposed, thereby functioning the mixture blasted from the blast opening forming strip shape as a grinding tool to remove the pollution and forming fine roughness on the surface to be restored, without grinding the underlying or peripheral parts of the surface of the member.

In this way, by using the blast media of a grainy material with the hardness equal to or less than that of the member to be restored, the choice of the blast media for a member can be narrowed down. Additionally, the mixture of the gas and the blast media is blasted onto the surface of the member using the nozzle with a slit as a blast opening of approximately rectangular shape, with a distance between long sides ranging from 0.5 mm to 1.5 mm. It is preferable for the blast opening to be a rectangular shape with rounded corners, where the long sides are straight and the short sides are curved (e.g., an oval shape). The ejected material ejected from such blast opening forms a narrow band of the blast media moving in the same direction as the nozzle's operating direction, functioning as a strip shaped dynamic “grinding tool”. This “grinding tool” is able to reach fine indentations like gouges, removing pollution by clashing the target. After clashing the target, the flow velocity of the blast media decreases or the particle size becomes smaller, avoiding grinding the surface to be restored of the target member.

On the surface of the target member for treatment, there are areas (pollution) that have deteriorated or become dirty need to be removed, and untarnished areas to be restored. The polluted areas are more fragile compared to the untarnished areas. These polluted areas and untarnished areas are adjacent within distances in millimeters or micrometers. However, it has been difficult for general blast treatments to perform a fine treatment like removing the pollution while avoiding grinding the untarnished areas to be restored on the surface of a member having fine texture with the scale of millimeters or less, such as gouges. In the present invention, by ejecting the aforementioned mixture from the aforementioned nozzle, the ejected band-shaped mixture functions as a grinding tool that can match the fine texture.

In this case, by adjusting the flow of the mixture through the flow path supplying the mixture to the nozzle with a flow control valve, the blasting conditions (either the ejection volume or the ejection velocity, or both) can be controlled, thereby regulating the intensity of the grinding by the “grinding tool” formed by the mixture ejected from the nozzle. Therefore, by adjusting the blasting condition, the blast treatment can be performed in such a way that it does not exert enough intensity to grind down the untarnished areas underlying or surrounding the pollution. This allows for the removal of fine pollution on the scale of millimeters or less while exposing untarnished areas without grinding them, thus restoring the surface of the member.

Here, on the exposed restored surface, tiny (typically with diameters ranging from tens to hundreds of micrometers) concavities are formed by the clash of fine particles of the blast media. As a result, the restored surface undergoes a roughening treatment, creating micro-scale fine roughness. This roughening treatment of the restored surface enhances the adhesion or impregnation of paint or other coatings, ensuring a more robust attachment or infiltration of paint or other coatings to the surface of the member making the restoration more secure.

In this way, the present invention enables to remove fine pollution on the scale of millimeters or less on the surface of the target member while controlling not to remove the untarnished areas to be restored. Additionally, it enables roughening treatment to be applied to the restored surface. Therefore, it is possible to retain the fine texture such as gouges with the scale of millimeters or less on the surface of the member, while removing the pollution.

The surface treatment according to the present invention preferably adjusts the blasting conditions to ensure that the nozzle reciprocates over the surface of the member no more than 10 times, preferably no more than 7 times, and more preferably no more than 5 times. Increasing the number of reciprocations of the nozzle over the surface of the member increases usage of the blast media or power, as well as dust emitted during the treatment, which is undesirable. There is no specific limitation on the minimum number of times the nozzle is moved over the surface of the member surface, which is at least once (half of one reciprocation). However, excessively strengthening the blasting conditions of the mixture to remove the pollution in an attempt to reduce the number of reciprocations of the nozzle over the surface of the member may increase the risk of the cleaning intensity being too strong, resulting in the disappearance of gouges or even excessive removal of the member's surface to be restored. Therefore, it is preferable to adjust the blasting condition to ensure that the nozzle reciprocates at least once to remove the pollution.

In the first aspect, the member may be a wooden member, and the method may use a plant-based blast media with an air-dried specific gravity greater than 0.5 as said first grainy material.

This enables easy selection of suitable blast media for blasting treatment of wooden surfaces. Moreover, it is preferable that the first grainy material, which is the main component of the blast media used, has a rounded shape. This is because using a rounded first grainy material helps to avoid damaging to the sound areas of the substrate (member) beneath the fragile and deteriorated areas while effectively removing the pollution. Additionally, the blast media may contain, as the second grainy material, either (A) plant-based blast media with an air-dried specific gravity of 0.5 or less or (B) mineral-based media. In cases where the member is painted and the paint is deteriorated, including the second grainy material allows for the removal of the deteriorated layer on tightly adhering paint film on the paint, facilitating the exposure of the wood grain of the member.

In the surface treatment method disclosed herein, the mixture of blast media and driving fluid functions like a long, narrow strip-shaped grinding tool, allowing it to reach the fine textures of the members and the gaps between members. Therefore, it is possible to perform blast treatment on each member while remaining part of the structure. This means that it is possible to treat each member of a structure with irregularities or gaps while the members are assembled and preventing damage to other members. Consequently, in the blast treatment of the members constituting the structure, the need for disassembly or reassembly of the structure can be eliminated.

Another aspect of a surface treatment method of the present disclosure may be a surface treatment method for a structure which removes pollution from an exposed surface of a member of the structure to restore the member, wherein the structure is a manufacturing facility for producing a particulate product that is ingested by an organism,
the member is polluted by a particulate deposit generated during the manufacturing process of the particulate product in the manufacturing facility,
and the surface treatment method using:
a blast media containing a first grainy material as a main component, where the first grainy material is composed of the same substance as the deposit in granular form, and
a blast treatment apparatus having a nozzle for blasting the blast media onto the surface of the member using a gas as a driving fluid, and a hollow tube for delivering a mixture of the blast media and the gas to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment blasting the mixture onto the surface of the member, thereby functioning the mixture blasted from the blast opening forming strip shape as a grinding tool to remove the pollution and forming fine roughness on the surface to be restored, without grinding the underlying or peripheral parts of the surface of the member.

Using the same substance as the deposit as the blast media allows for the removal of the pollution by utilizing the adhesive force (affinity) of the same substance. And in this aspect, components can be cleaned while remaining integrated into the manufacturing facility, eliminating the need to disassemble the parts. Additionally, by using the same substance as the particulate manufactured (the particulate product) as the blast media, it is possible to remove excess particulates adhering to the parts and to perform a cover treatment busting cover substance onto the cleaned surface. The term “cover treatment” refers to the process of dusting fine particulates to be adhered to sliding areas of driving components, and it is preferable to use particulates with smaller particle sizes than those of the particulate product. Furthermore, this “cover treatment” is an example of the aforementioned “roughening treatment,” which forms fine roughness on the restored surface. In this specification, a treatment that forms fine roughness (such as those of millimeters or less) on the surface of the member is referred to as “roughening treatment.” The roughening treatment includes forming fine roughness by creating fine depressions on the surface of the member and forming fine roughness by depositing grainy material on the surface of the member. In this specification, particularly when there is a need to distinguish between the two, the former may be referred to as “roughening treatment by depression formation” and the latter as “roughening treatment by grainy material adhesion.

In the foregoing embodiment, it is preferable that the blast media has a lower hardness than the member. By using a material for the blast media that has lower hardness than the member, it is possible to remove (grind) the pollution, which is adherent to the member and is of the same material as the blast media, by utilizing the peeling force of the blast media while avoiding abrasion (shaving) of the member even when the mixture of the blast media and the driving fluid (gas) is ejected rather strongly. Especially in cases where a large amount of deposit adheres to the target member and its surface is not exposed, it may be desirable to increase the grinding function of the “grinding tool” formed by ejecting out the mixture by increasing the flow rate of the mixture. In such cases, by using a material for the blast media that has lower hardness than the member, surface treatment can be continued without changing the ejecting conditions of the mixture even when the surface of the target member is exposed during treatment. However, it is preferable to provide a discharge control unit for adjusting the flow rate of the mixture supplied from the hollow tube to the nozzle, and to adjust (change) the flow rate of the mixture and perform surface treatment by blowing (blasting) when the surface of the target member is exposed during treatment.

### Advantageous Effects of Invention

According to the surface treatment method and blast treatment apparatus disclosed herein, it is possible to easily determine the treatment conditions for cleaning a structure through blast treatment. In particular, according to the surface treatment method and blast treatment apparatus disclosed herein, the restored surface (such as the healthy portion called “wood grain” beneath deteriorated wood, undamaged strong winter grain, and black rust layer formed beneath red rust layer as a pollutant) can be removed from pollution to be exposed without being erased or shaved. Additionally, according to the deposit removal method of a manufacturing facility for manufacturing a particulate product disclosed herein, it is possible to easily remove deposits adhering to components incorporated in the manufacturing facility.

### BRIEF DESCRIPTION OF DRAWINGS

FIG. 1 is a flowchart illustrating an example process of the surface treatment method.

FIG. 2 is a flowchart illustrating an example process of manufacturing refined sugar from raw sugar.

FIG. 3 is a schematic diagram illustrating the configuration of an air blast apparatus that can be used in the sugar removal method according to the present embodiment.

FIG. 4(A) is a plan view showing the entire blast nozzle, FIG. 4(B) is a side view of the blast nozzle, and FIG. 4(C) is an enlarged perspective view showing around the blast opening of the blast nozzle.

FIG. 5 is a schematic diagram illustrating the process of sugar removal process performed by an operator.

FIG. 6(A) and FIG. 6(B) are schematic diagrams illustrating the configuration of a nozzle with a light attached.

### DESCRIPTION OF EMBODIMENTS

### Example 1

The following describes a surface treatment method for a structure and a blast treatment apparatus according to the present disclosure. It should be noted that the methods described below are merely embodiments of the present invention. Therefore, the present invention is not limited to the following embodiments, and additional, deletion, or modification of the configuration is possible within the scope of the invention without departing from the spirit and scope of the invention.

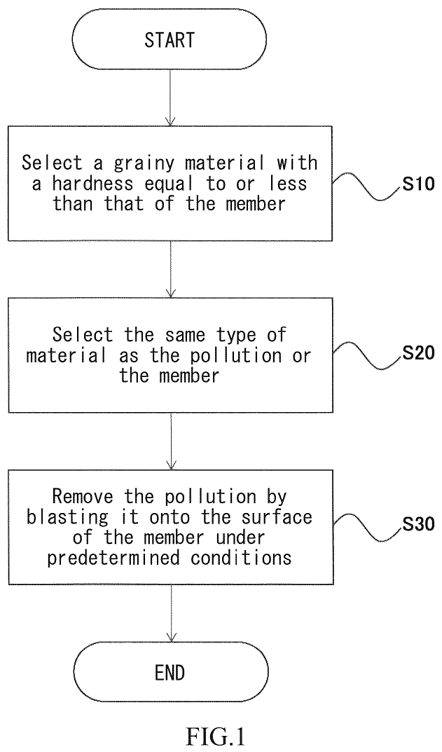

The surface treatment method according to the present disclosure involves removing pollution from the surface of a member that constitutes a structure and is exposed to the environment, using a blast media containing a first grainy material as the main component. This first granular material has a hardness equal to or less than that of the member and preferably does not pollute the environment even when dispersed into the environment. As shown in the flowchart of FIG. 1, this surface treatment method includes a step (Step S10) of selecting grainy material with a hardness equal to or less than that of the member based on the type and condition of the target member, a step (Step S20) of selecting material among the material selected in the aforementioned step and similar to the pollution or the material of the member, and a step (Step S30) of blasting the selected blast media onto the surface of the member under predetermined conditions to remove pollution. It should be noted that Steps S10 and S20 may be interchangeable or one may be omitted.

Examples of the blast media chosen in the Step S10 as a substance that, even if dispersed in the environment, do not pollute the environment include blast media derived from natural resources, specifically plant-based and mineral-based blast media. Plant-based blast media, in particular, are biodegradable and easily adjustable in terms of hardness, particle size, and shape, making them preferable blast media. Additionally, plant-based blast media are suitable for treating various types of materials, including wood, mineral like materials such as ceramics including earthenware and pottery, concrete, stone, and metals like iron and copper, as well as polymers like synthetic resins and rubber. When the target for removal is deposits or dirt, it is preferable to use a blast media that is the same substance as the pollution and softer than the member being treated and harder than the pollution. It is acceptable to mix two or more types of blast media. It is preferable to use plant-based blast media as the main component, along with blast media of different hardness as the subsidiary component.

Furthermore, if the pollution is a deposit adhering to the member covers it to the extent that the surface of the member is not exposed, it is advisable to select blast media of the same material as the pollution in Step S20. In particular, in the case of manufacturing facilities for particulate products ingested by humans or animals (hereinafter referred to as “ingestible materials”), where the components constituting the manufacturing facility are polluted by the particulate deposit (such as the particulate product itself or the powders of different particle sizes but with the same substance as the particulate product), generated during the manufacturing process of the particulate product, it is preferable to select blast media composed of the same material as the deposit as “the blast media of the same material as the pollution”. The term “ingestible materials” includes, but is not limited to, sugar, salt, seasonings, other food items, and pharmaceuticals. Additionally, when the deposit consists of a mixture of multiple kinds of particulates, it is acceptable as “the same material as the deposit” in which at least one kind of the particulates is the same material as the deposit.

In Step S20, the range of selection for blast media may include the same substance as the member rather than pollution. That is to say, it is permissible to choose the same substance as either the pollution or the member as blast media. Here, when the pollutions or the members are classified into categories such as wood, ceramics or stone, metals, polymers, and ingestible materials, blast media consisting of materials included in the corresponding category are considered “of the same type”. It is not essential for the identity to extend to further subcategories within the same classification (excluding ingestible materials). For instance, if the pollutions or the member are wood such as zelkova or Japanese cypress, blast media made from the same type of wood, such as zelkova or Japanese cypress, may be used. But it is not limited to this, and for example, if the target member is pine or zelkova having a high-hardness, blast media made from Japanese cypress having lower hardness may be chosen. Plant-based blast media vary in air-dried specific gravity depending on the plant species (see Patent Document 2), and higher air-dried specific gravity tends to indicate higher hardness. Therefore, it is permissible to determine blast media based on air-dried specific gravity as an indicator of hardness. Plant-based blast media with an air-dried specific gravity greater than 0.5 may be used as the first grainy material, and those with an air-dried specific gravity of 0.5 or less may be mixed as the second grainy material depending on the type and condition of the target member. Suitable examples of plant-based blast media as the first grainy material include seed husk of walnut, peach or apricot, and corn cob cores.

A substance with the same or lower hardness as the target member is selected as the first grainy material that serves as the main component of the blast media to minimize damage to the vicinity and untarnished areas of the member of the structure. Conversely, in cases where the pollution has become changed and relatively hard, a first grainy material, which has a higher hardness than the pollution but lower hardness than the member can be selected as the main component of the blast media.

The term “specific gravity” used here should be determined considering the conditions (such as moisture content) when each blast media selected through Steps S10 and S20 is actually used for blast treatment. It is preferable to blast the blast media onto the target member as a mixture with a driving fluid, such as gas, or ideally with dehumidified air being dried. When the blast media contains moisture, it can adhere to the internals of nozzles or form clumps, hindering the formation of a strip shape ejection functioning as a sharp grinding tool.

The term “main component” of the blast media refers to the component the number of the particles of which is bigger than that of the other secondary components being sprayed onto the target. Generally, in the blast media stored in the blast media tank to be blasted from the nozzle of the blast treatment apparatus, if the number of a first kind of grainy material exceeds that of the other second or third kind of grainy material, the first kind of grainy material becomes the main component, while the other second or third kind of grainy material are considered secondary components. The proportion of the first grainy material, which constitutes the main component, in relation to the entire blast media, typically ranges from over 30% to less than 100%, depending on the number of kinds of grainy materials used as secondary components.

The first grainy material that serves as the main component of such blast media is exemplified as follows. For instance, when the member of the structure is wood, the main component is a plant-based blast media with an air-dried specific gravity greater than 0.5, and preferably, a plant-based blast media with a rounded shape is particularly suitable as the first grainy material serves as the main component.

Here, regarding the “air-dried specific gravity” of plant-based blast media, when the blast media is wood, the apparent density at approximately 15% moisture content, in which the ratio of the weight of the wood at approximately 15% moisture content to the weight of water with the same volume as this wood, can be used. Additionally, when the blast media is plant-based other than wood, with a moisture content ranging from 5% to 10%, the ratio at the actual moisture content when used for blasting can be used.

Furthermore, the term “rounded” shape refers to a shape where the edges are noticeably rounded compared to particulate blast media made from crushed plant material immediately after crushing when observed under a microscope. There is no specific limitation on the methods to achieve such rounding. One example is to place particulate blast media with edges into a metal tumbler equipped with blades or protrusions on the inner surface, and to rotate the tumbling axis horizontally or at an angle of less than 45 degrees while rotating at a speed ranging from 60 to 100 rpm for about 20 to 30 minutes.

In addition, for the aforementioned plant-based blast media, those with an average median diameter ranging from 0.01 mm to 2.5 mm can be used, with a preferable range being from 0.02 mm to 0.8 mm. Blast media of such diameters can be obtained by sieving through a vibrating sieve machine equipped with micron mesh. Furthermore, the obtained blast media particle size can be measured, for example, using a laser diffraction/scattering particle size distribution analyzer.

Furthermore, the surface treatment method disclosed herein may include a second grainy material as the secondary components in addition to the main component mentioned above. As for the second grainy material of the blast media, the following are specifically exemplified:

In the case where the member constituting the structure is painted wood with painted surfaces deteriorated:
(A) Plant-based blast media with an air-dried specific gravity of 0.5 or less, or
(B) Mineral-based media are suitable for the second grainy material serves as the secondary component.

In this surface treatment method, blast media containing the aforementioned first and second grainy materials are used to remove the deteriorated layer as the pollution on the tightly adhering paint of the paint film on the member and expose the wood grain including the tightly adhering paint beneath the deteriorated layer.

In addition, among the mineral-based media, it is permissible to form them using one or more materials selected from the group including, for example, stone powder, sand, baking soda, calcium carbonate, shell powder, glass powder, and ceramic powder. Here, in the disclosure, “mineral-based media” typically refers to those composed of naturally occurring inorganic crystalline substances, but may also include artificially synthesized inorganic crystalline substances, as well as biominerals such as shells and teeth, and substances generally considered minerals even if they are non-crystalline, such as opal.

The surface treatment method disclosed herein involves selecting the blast media in this manner (S10, S20), followed by blasting the selected blast media onto the surface of the member using a driving fluid under predetermined conditions to remove the pollution (Step S30). Here, the “predetermined conditions” of Step S30 are explained.

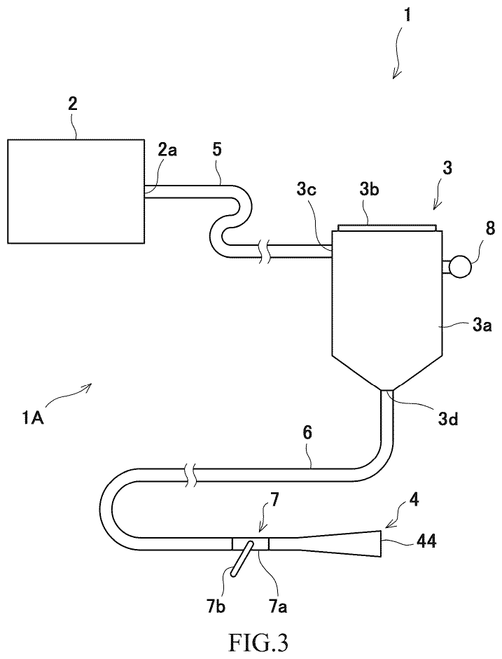

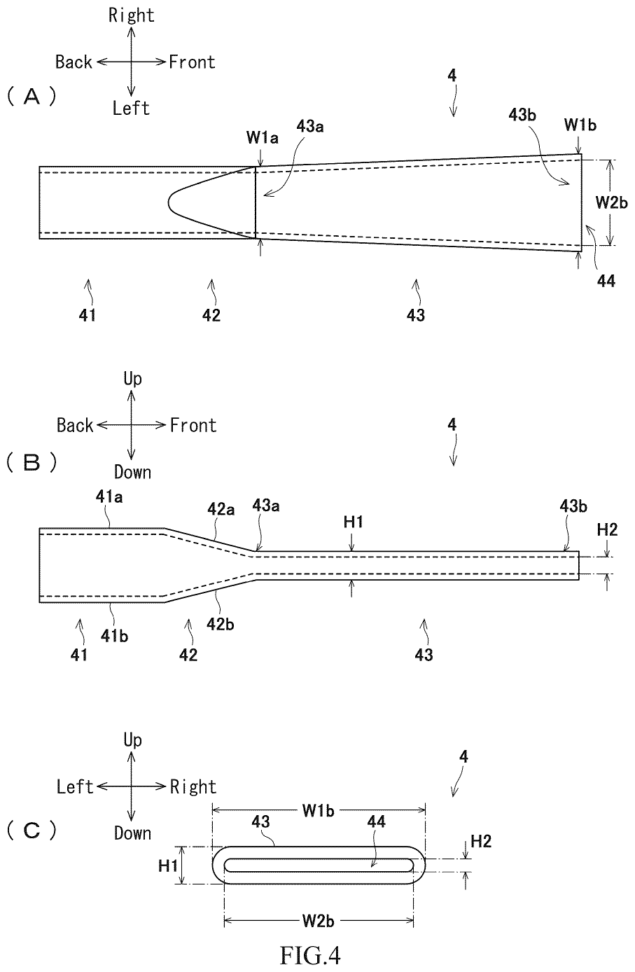

Firstly, the predetermined conditions include the use of a blast treatment apparatus equipped with a hollow tube, a nozzle, and a discharge control unit. More specifically, this blast treatment apparatus comprises a nozzle that blasts the blast media onto the surface of the member using gas as the driving fluid, a hollow tube that delivers the mixture of blast media and gas to the nozzle, and a discharge control unit that regulates the flow of the mixture supplied from the hollow tube to the nozzle. Additionally, it is preferable to use a nozzle that has a tubular base connected to the hollow tube, and a tip extending from the base to an end of the nozzle through an intermediate portion, wherein the tip has a nearly rectangular-shaped blast opening with a distance between long sides ranging from 0.5 mm to 1.5 mm. Such a blast treatment apparatus may include configurations as disclosed in the FIGS. 3 and 4 described later.

Furthermore, the predetermined conditions mentioned above include blasting the mixture onto the exposed surface of the member while adjusting the flow rate of the mixture using the nozzle of the blast treatment apparatus as described above. Additionally, the predetermined conditions include removing the pollution to expose the surface to be restored underlying or peripheral areas of the pollution of the member without shaving the surface to be restored by the blasting mentioned above wherein the strip-shaped mixture ejected from the blast opening is functioned as a grinding tool to remove the pollution, and performing a roughing treatment to form fine roughness on the surface to be restored.

Furthermore, the surface treatment method described above may involve spraying the blast media onto the surface of the member while the member is incorporated in the structure. For example, when performing blast treatment on members with sculptures or decorated such as latticework installed between the ceiling and the lintel for ventilation or lighting in a building like a temple or a shrine or the like, it is possible to perform the blast treatment without disassembling the member from the building, remaining them in their used state. Similarly, in the case of a structure serving as an elevator for transporting sugar in a sugar refinery, it may be permissible to perform blast treatment on the components of the elevator, such as the buckets and chains, without disassembling them, leaving them in their assembled state.

According to the surface treatment method described above, among the numerous parameters including the kinds of blast media, it is possible to easily select treatment conditions suitable for the target object. After selection in Steps S10 and S20, further optimization of blast media and various treatment conditions may be performed, considering factors such as the condition of the pollution or member, and the working environment. The treatment conditions thus determined are suitable for surface treatment of the target member, resulting in a lower risk of damaging untarnished parts or surrounding areas of the member compared to generally applicable conventional treatment conditions. Therefore, it is possible to perform blast treatment of the target member while it remains in its assembled state. Additionally, using blast media that is the same as the pollution or member allows for blast treatment of the member without disassembling the member, as seen in sugar refinery, while it remains in its structural assembly.

In the case of blast treatment in manufacturing facilities for ingestible materials such as sugar or salt factories, as mentioned above, the specifics will be discussed separately later. For instance, in situations like those in sugar factories where the manufactured particulate product is sugar and it's necessary to remove sugar adhered to a member of a structure like an elevator, granulated sugar with relatively low hygroscopicity can be suitably used as the first grainy material for the blast media.

### Example 2

Next, we'll explain the method for removing deposit in one specific example of the surface treatment method described above, which pertains to an embodiment of the present disclosure for removing deposits adhered to manufacturing facility for particulate products, with reference to the drawings. It should be noted that the method described below is merely one embodiment of the present invention. Therefore, the present invention is not limited to the following embodiments, and additional, deletion, or modification of the configuration is possible within the scope of the invention without departing from the spirit of the invention. Furthermore, while we mainly illustrate the method for removing sugar from components of sugar manufacturing facility as an example of a deposit removal method, similar procedures can be applied for removing salt from components of salt manufacturing facility, or for removing adhered deposits from manufacturing facility for particulate products comprising ingestible materials.

### [Sugar Manufacturing Process]

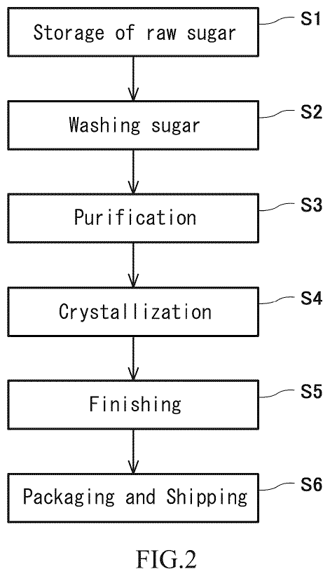

First, the process of manufacturing sugar is explained. FIG. 2 is a flowchart illustrating an example of the process for producing refined sugar from raw sugar. As shown in FIG. 2, in the process of producing refined sugar, raw sugar produced from sugarcane or sugar beet in various locations is collected and stored in warehouses (Step S1). The raw sugar stored in the warehouse is then transported to the refining plant via conveyors or similar means. In the plant, during the process known as “washing sugar” (Step S2), the raw sugar and sugar solution are stirred together, then separated into crystals and syrup containing impurities. Additionally, the obtained crystals are dissolved in warm water to form sugar solution.

Next, in the purification process (Step S3), lime milk and carbon dioxide are added to the sugar solution obtained in the washing sugar process, and this reaction causes impurities in the sugar solution to coagulate. By filtering this solution, a yellow-brown transparent sugar solution is obtained. Furthermore, the yellow-brown transparent sugar solution is passed through ion exchange resin to further remove impurities, then sterilized by exposure to ultraviolet light, and finally concentrated.

The crystallization process (Step S4) involves adding seed (crystal nuclei) to the concentrated syrup to induce crystallization. In the finishing process (Step S5), the mixture of crystals and syrup produced in the crystallization process (known as “massecuite”) is separated into crystals and molasses using a centrifuge. The separated crystals are then dried and cooled for finishing, and subsequently stored in silos or similar containers under controlled temperature conditions according to the type of product. In the final packaging and shipping process (Step S6), the sugar stored in silos or similar containers is sieved to achieve the desired particle size range, then packaged into bags suitable for the intended use and shipped out.

Here, for example, when storing the refined sugar produced in the finishing process (Step S5) in silos or similar containers, the sugar is transferred vertically and horizontally using elevators consisting of buckets and chains, as well as vibrating conveyors. When sugar adheres to the drive components of these elevators and conveyors, it can become firmly stuck due to the high-pressure rubbing at the sliding areas of the drive components.

The deposit removal method disclosed herein is suitably applied, for example, to remove deposits adhered to such drive components. However, the application scope of the deposit removal method disclosed herein is not limited to this, and it can be used for various facilities used in the manufacturing processes of particulates such as salt, seasonings, and chemicals. Taking sugar production as an example, it can be suitably used for removing sugar adhered to equipment used in the manufacturing facilities of all sugars (refined sugar and raw sugar), including equipment used in facilities for producing syrup-containing sugar. Furthermore, it can be used not only for drive components but also other components or floors, walls, and likes to remove sugar adhered to them.

### [Air Blast Apparatus]

FIG. 3 is a schematic diagram illustrating an example of an air blast apparatus (blast treatment apparatus) that can be used in the sugar removal method according to the present embodiment. Additionally, this blast treatment apparatus can be used not only for the sugar removal method but also for the surface treatment method of the structure described in embodiment 1 as explained with reference to FIG. 1. It should be noted that the air blast apparatus according to the present embodiment exemplifies the use of air as the driving fluid for the blast media, but other gases may also be used as the driving fluid. As shown in FIG. 3, the air blast apparatus 1 includes an air compressor 2, a blast media tank 3, a blast nozzle 4, and hoses 5 and 6 connecting these components. Among these, the air compressor 2, blast media tank 3, and hoses 5 and 6 constitute a blast media supply device 1A for supplying blast media to the blast nozzle 4.

The air compressor 2 generates dry compressed air and discharges it from the discharge port 2a, and can, for example, have an output of several kW at 200V three-phase. A dryer for drying the air may be integrated into the air compressor 2 or may be provided separately from the air compressor 2. For instance, a gas storage tank (not shown) may be provided between the air compressor 2 and the blast media tank 3 to store compressed air in the gas storage tank and dry the driving fluid (in this case, air). In this embodiment, the upstream end of hose 5 is connected to the discharge port 2a of the air compressor 2, and the downstream end of hose 5 is connected to the blast media tank 3. The hose 5 is made of, for example, a flexible tube and has a predetermined strength to withstand the pressure of the compressed air discharged from the discharge port 2a.

The blast media tank 3 comprises a tank body 3a with a predetermined volume, and an opening openable and closable by a lid 3b is provided at the top of this tank body 3a. The blast media are introduced into the tank body 3a through this opening. Additionally, an inlet 3c is provided on the upper side of the tank body 3a, and the downstream end of the hose 5 is connected to this inlet 3c. A supply port 3d is provided at the bottom of the tank body 3a, and the upstream end of hose 6 is connected to this supply port 3d. The downstream end of hose 6 is connected to the blast nozzle 4 via a valve unit 7, which includes an operating tool 7b for adjusting the flow rate of the mixture of the driving fluid (dry air) and the blast media as a discharge control unit, and a tubular body 7a as a hollow tube. Similar to hose 5, hose 6 is made of, for example, a flexible tube, and has a predetermined strength to withstand the pressure of the blast air, which includes the blast media supplied from the supply port 3d, and flexibility for ease of operation by the operator. Additionally, the blast media tank 3 is equipped with a pressure gauge 8. The pressure gauge 8 is provided, for example, on the upper side of the tank body 3a and can measure and output the internal pressure of the tank body 3a.

The granular sugar (or later mentioned “salt,” etc.) used as the blast media tends to aggregate due to moisture. Therefore, it may be beneficial to install a vibrator or agitator in the tank body 3a of the blast media tank 3. This applies vibration to the media inside the tank body 3a, or agitates the media, thereby suppressing aggregation. As a result, individual granular media or relatively small-sized media, even if aggregated, can be smoothly dispensed from the supply port 3d. Known devices such as turbine-type vibrators, which generate vibration by rotating a turbine with eccentric weights using air flowing through the hose 5, can be employed as such vibrators or agitators.

The valve unit 7 is interposed between the downstream end of the hose 6 and the blast nozzle 4, comprising the tubular body 7a and the operating tool 7b. One opening end of the tubular body 7a is connected to the downstream end of the hose 6, while the other opening end is connected to the blast nozzle 4, allowing the blast air sent from the hose 6 to be directed to the blast nozzle 4 through the tubular body 7a. Within the tubular body 7a, a valve (not shown) is provided to open and close the internal flow passage of the tubular body 7a, which is driven by operating the operating tool 7b. By driving the valve, the internal flow passage of the tubular body 7a can be opened and closed, allowing for continuous adjustment of the opening degree between fully open and fully closed to adjust the blast conditions of the mixture of the driving fluid and the blast media.

The blast nozzle 4 is a so-called flat nozzle, having a flat-shaped blast opening 44. FIG. 4(A) is a plan view showing the entire blast nozzle 4, FIG. 4(B) is a side view of the blast nozzle 4, and FIG. 4(C) is an enlarged perspective view showing the vicinity of the blast opening 44 of the blast nozzle 4. It should be noted that, in explaining the structure of the blast nozzle 4, the concept of direction considers the longitudinal direction (the flow direction of the blast air) of the blast nozzle 4 as the front-back direction, the lateral direction as the left-right direction, and the direction orthogonal to both as the up-down direction. Additionally, the dashed lines in FIG. 4(A) and FIG. 4(B) indicate the outline of the internal flow passage of the blast nozzle 4.

As shown in FIG. 4(A), the blast nozzle 4 comprises a base 41 connected to the valve unit 7, an intermediate portion 42 extending forward from the base 41, and a tip 43 further extending forward from the intermediate portion 42. In this embodiment, the blast nozzle 4 is metallic, and the base 41, the intermediate portion 42, and the tip 43 are integrally formed.

The base 41 forms a cylindrical tube, with its inner diameter matching or nearly matching that of the tubular body 7a of the valve unit 7. The intermediate portion 42 is the part extending forward from the front end of the base 41, and when viewed from the side, it gradually decreases in thickness (height dimension) from the rear end to the front end, forming a wedge shape. More specifically, as shown in FIG. 4(B), the intermediate portion 42 of the blast nozzle 4 forms an isosceles triangle shape when viewed from the side, with the upper end 42a and lower end 42b forming oblique lines with the front end as the apex. Therefore, in side view, the upper end 42a of the intermediate portion 42 intersects the upper end 41a of the base 41 at a predetermined angle, and the lower end 42b of the intermediate portion 42 also intersects the lower end 41b of the base 41 at the same predetermined angle.

The tip 43 is the part that extends further from the front end of the intermediate portion 42, and when viewed from the side, the vertical dimension (height dimension) H1 remains approximately constant from the rear end 43a to the front end 43b. However, as shown in FIG. 4(A), when viewed from above, the outer lateral dimension (width dimension) of the tip 43 is larger at the front end 43b than at the rear end 43a, and gradually increases at a constant rate from the rear end 43a to the front end 43b. In other words, the tip 43 forms a trapezoidal shape in plan view, with the rear end 43a as the upper base and the front end 43b as the lower base. Similarly, it is preferable that the width dimension of the inner diameter of the tip 43 of the blast nozzle 4 is larger at the front end 43b than at the rear end 43a, and gradually increases at a constant rate from the rear end 43a to the front end 43b.

As shown in FIG. 4(C), the blast opening 44 is formed at the front end 43b of the tip 43. This blast opening 44 forms a flat-shaped aperture with a height dimension H2 in the vertical direction (second direction) smaller than the width dimension W2b in the horizontal direction (first direction). Additionally, the height dimension H2 of the blast opening 44 remains approximately constant at any position in the horizontal direction (width direction).

### [Removal Process of Sugar]

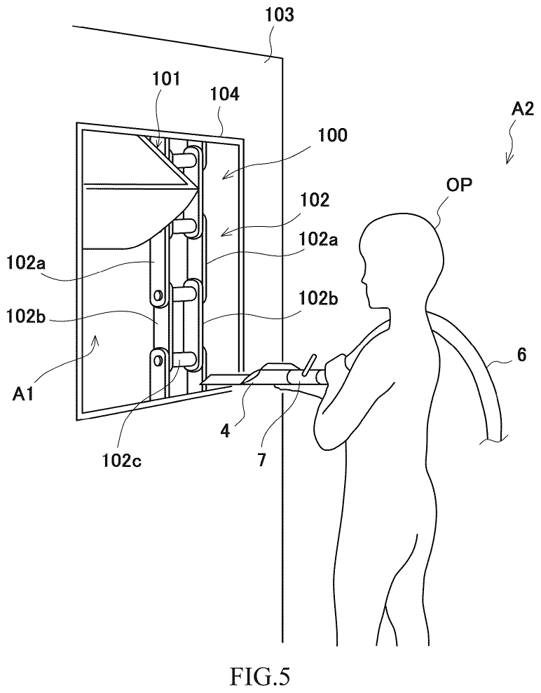

Next, the sugar removal process using the air blast device as described above. FIG. 5 is a schematic diagram showing the sugar removal process performed by the operator. In this figure, sugar is being transported upwards by the elevator 100. The elevator 100 is also known as a bucket elevator and is equipped with buckets 101 and chains 102. These buckets 101 and chains 102 serve as examples of the components to be desugared.

The bucket 101 is a container with a predetermined capacity and an opening at the top, made of stainless steel or synthetic resin. The chain 102 used here is a roller chain, with roller 102c inserted between pairs of outer plates 102a, 102a and pairs of inner plates 102b, 102b, connected by pins and bushes. Such chains 102 suspend the bucket 101 on both sides and convey it upwards.

In the factory, the area where sugar is transported by the elevator 100 is spatially separated from the area where operators, such as OP, work. In the case of FIG. 5, the transport area A1 is the region where the elevator 100 works, while the work area A2 is where the operator OP works. The transport area A1 and work area A2 are separated by a door 103, which has an operable window 104. In FIG. 5, it shows an example of sugar removal work being conducted through the open window 104.

During the sugar removal process, the transportation of sugar by the elevator 100 is interrupted. Ideally, the sugar loaded in the buckets 101 of the elevator 100 is discharged. In the sugar removal process, the operator OP places a predetermined amount of granular sugar, which serves as the blasting media, into the tank body 3a of the blast media tank 3 and closes the lid 3b. Next, the operator drives the air compressor 2 and confirms through the pressure gauge 8 that the internal pressure of the tank body 3a of the blast media tank 3 has reached the predetermined pressure. Meanwhile, the operator maintains the operating tool 7b of the valve unit 7 in the closed position. Subsequently, as shown in FIG. 5, the operator OP hangs the hose 6 extending from behind over their right shoulder, grips the tip of the hose 6 with their left hand, and holds the blast nozzle 4 with their right hand. In this position, the operator directs the blast nozzle 4 held in their right hand toward the sugar removal target and operates the operating tool 7b of the valve unit 7 from the closed position to the open position. This causes sugar, the blasting media, to be ejected from the blast nozzle 4 and blown onto the sugar removal target.

During the sugar removal process, it is permissible to drive the elevator 100 in the upward or downward direction at a predetermined constant speed. This speed can be the same as or slower, or faster of the transfer speed during sugar manufacturing. By driving the elevator 100 while blasting sugar, the sugar removal process can proceed smoothly, and blasting media (sugar) can be blasted onto the sliding areas of the driving components. Therefore, it is possible to remove adhered sugar from the sliding areas and also to “coat” these sliding areas with blasting media (sugar).

After the sugar removal is completed, the elevator 100 is driven to make a predetermined number of rotations, causing any remaining blasting media (sugar) to fall off or accumulate in the buckets 101 and other areas, and then discarded from the elevator 100. This prevents the sugar produced after the sugar removal process from being mixed with the sugar used as blasting media. Additionally, it is permissible to use pressurized air blowing that does not contain blasting media to discard the remaining sugar.

By the way, due to humidity within the facility, sugar can adhere more strongly to the driving components. In such a case, simple blasting with blast media may not effectively remove the firmly attached sugar. For instance, when attempting to removing sugar after the factory has been idle for several days, such issues might arise. In such cases, it is preferable to introduce specific variations in the blasting the blast media.

One possible variation to introduce is to oscillate the blast nozzle 4 with a predetermined amplitude and frequency while blasting the blast media. More specifically, this can involve repeatedly moving the blast nozzle 4 back and forth within a predetermined angular range in the vertical or horizontal direction, for example, while blasting the blast media. Such motion can be achieved by manually moving the hand that grips the blast nozzle 4 by the operator (OP), or it can be realized using mechanical configurations such as a reciprocating mechanism.

If mechanically realized, this could involve supporting a portion of the blast nozzle 4 to be capable of rotation, and a crank connected to the rear end of the blast nozzle 4 being rotated by a mechanism such as an electric motor. Alternatively, a vibrator capable of generating vibrations at a predetermined frequency could be attached to the blast nozzle 4 or somewhere along the hose 6. As for vibrators, options include the turbine-type vibrator mentioned earlier or other known electric vibrators.

Another example of introducing variation could be to make the blasting of the blast media from nozzle 4 intermittent. More specifically, this could involve intermittently varying the density of the blast media ejected from nozzle 4. Such a mode could be achieved by adjusting the amount of blast media supplied to nozzle 4. For instance, a flow control valve capable of adjusting the flow rate of the blast media (and air) supplied to the nozzle 4 could be provided at any point along the path from the supply port 3d of the blast media tank 3 or along the hose 6, between the tank body 3a and the nozzle 4. Then, the opening degree of this flow control valve can be repeatedly changed over time. This would allow for intermittent variation in the density of the blast media ejected.

### [Another Embodiments]

Hereafter, technologies applicable to one or more of the embodiments 1 and 2 described above are explained.

### [Preferred Embodiments for the Sugar Removal Method]

The preferred specifications for the sugar removal method using the air blast apparatus 1 as described above are explained.

The sugar used as blast media preferably has an average particle size ranging from 200 μm to 500 μm, with a coefficient of variation ranging from 0.20% to 0.30%. The coefficient of variation, here, indicates the degree of particle size variation, calculated by dividing the standard deviation by the mean and multiplying by 100%. In this embodiment, granulated sugar with an average particle size of 493 μm and a coefficient of variation of 0.28% is used. However, the use of a single type of sugar as blast media is not mandatory. For instance, it's permissible to blend two or more types of sugar to be used as the blast media. In such cases, a mixture of sugars with relatively larger particle sizes for removing sugar and those with relatively smaller particle sizes for covering can be used.

Furthermore, in cases other than sugar, it is preferable to select grainy materials for blast media that have either a larger particle size or specific gravity compared to the particulate that adhere to the manufacturing facility, or have both properties larger.

The height dimension H2 (in the second direction) of the blast opening 44 is preferably 1.6 times to 4.0 times the average particle size of the blast media, not only when used in the sugar removal method disclosed herein but also when used in the surface treatment method disclosed herein. In particular, to function as a grinding tool for a gas-solid mixture by blasting a band-shaped mixture of particulate blast media with a median diameter in the micron range, the blast opening preferably has a height dimension (distance between the long sides of the rectangular shape) of ranging from 0.5 mm to 1.5 mm, more preferably from 0.7 mm to 1.0 mm for the narrow rectangular shape, with the short sides being a curved slit, particularly an arc shape. In this embodiment, a blast opening 44 with a height dimension H2 of 0.8 mm is employed. Additionally, it is preferable for the inner diameter of the tip 43 of the blast nozzle 4 to be larger at the front end 43b than at the rear end 43a, and to gradually increase at a constant ratio from the rear end 43a to the front end 43b. For example, it is preferable that the ratio of W2b/W2a is 1.1 or more and 1.5 or less. In this embodiment, the length of the tip 43 is 150 mm, the width dimension W2a of the inner diameter at the rear end 43a is 25 mm, and the width dimension W2b of the inner diameter at the front end 43b is 35 mm (W2b/W2a=1.4).

The gas pressure for ejecting the blast media is preferably within the range of 0.4 MPa to 0.9 MPa as the internal pressure of the blast media tank 3.

The sugar removal method according to the embodiment 2 can be applied to manufacturing facility for all types of sugar, including refined sugar and raw sugar, but it is particularly suitable for use with the driving components of facility for manufacturing white well-refined sugar. White well-refined sugar, containing inverted sugar (including monomeric fructose), has high hygroscopicity and tends to adhere to various parts of the facility, requiring significant effort for sugar removal in the past. Therefore, by applying the sugar removal method described above, significant savings in labor and cost can be achieved, thus achieving a specific beneficial effect.

The embodiments described above are exemplary and the configuration of the present invention is not limited thereto. For example, the type of grainy material to be removed, the type of granular material used as blasting media, the configuration of the air blast apparatus (deposit removal apparatus) 1 including the configuration of the blast nozzle 4, and the gas pressure for ejecting the blasting media are not limited to the parameters described above and other parameters may be used. For instance, depending on factors such as the type of deposit, the location of adhesion, or the angle of blast (impact angle), a blast nozzle with a cross-section of the blast opening that is not substantially rectangular may be used. Such a blast nozzle could have an inner diameter, for example, of 1.5 mm to 10 mm. Additionally, the target for removal need not be limited to elevators or conveyors, and it may encompass other components of manufacturing equipment, not necessarily restricted to driving components.

Furthermore, while embodiment 2 specifically described a method for removing sugar in sugar manufacturing facility, a similar approach can be applied for removing salt in salt manufacturing facility. In this case, granular salt can be used as the blasting media. Moreover, the method for removing deposits can be applied to manufacturing facility for seasoning products such as condiments containing amino acids and other substances in particulate form, as well as pharmaceuticals and other drugs containing chemical substances in particulate form. Additionally, there is a need to avoid the possibility of contamination, especially due to wear and tear of manufacturing facility during the manufacturing process. This method can be suitably applied to the manufacturing facility of particulate, including those intended for ingestion by humans and animals.

According to the embodiment 2, the method eliminates or reduces the need for equipment disassembly during deposit removal and minimizes or eliminates the use of solvents such as hot water typically used for deposit removal. This reduction in solvent use contributes to lowering the emission of carbon dioxide associated with the consumption of chemicals and energy in the production process of particulates. The disclosure is particularly suitable for cases where a “covering treatment” is required after deposit removal.

### [Example of a Modified Blast Treatment Apparatus]

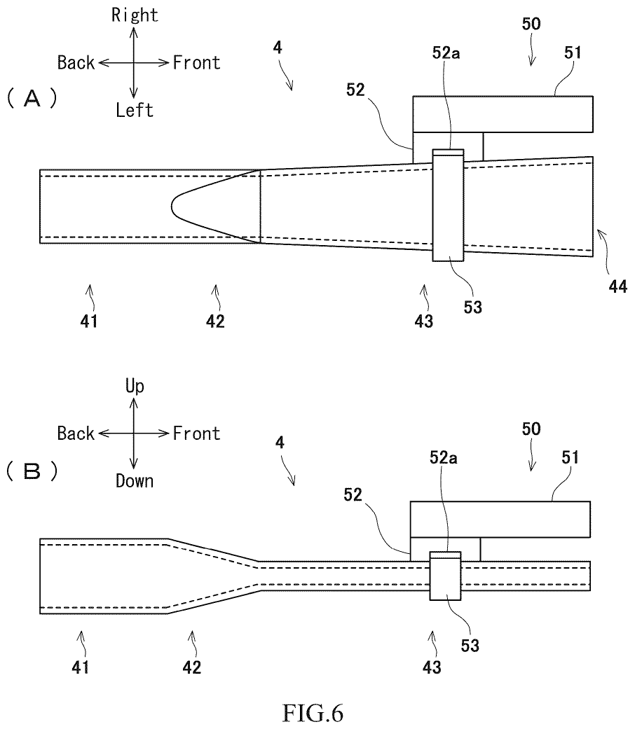

When implementing the surface treatment method disclosed herein, as already explained, it is possible to perform blast treatment on the member of a structure without disassembling them, leaving the structure intact. However, in such cases, there may be difficulties in visual inspection due to objects being in shadow or other reasons. Therefore, it may be appropriate to provide a light that illuminates the member being blasted by the nozzle of the blast treatment apparatus. FIGS. 6(A) and 6(B) are schematic diagrams showing the configuration of a nozzle equipped with a light. It should be noted that the configuration of the nozzle 4 excluding the light 50 in FIGS. 6(A) and 6(B) is the same as the flat nozzle 4 described using FIG. 4.

In the case of FIG. 6(A), the light 50 is provided on the lateral sides (in the width direction, i.e., left and right directions) of the flat tip 43 of the nozzle 4. The light 50 has a cylindrical main body portion 51, and the axis of the main body portion 51 is nearly parallel to the longitudinal direction (front-to-back direction) of the nozzle 4. The light 50 has a supporting portion 52 provided at the rear of the main body portion 51. The supporting portion 52 supports the main body portion 51 at a predetermined distance from the tip 43 of the nozzle 4. The supporting portion 52 has a through hole 52a formed in the vertical direction, through which a belt 53 is passed and wound around the tip 43 of the nozzle 4, thereby fixing the supporting portion 52 to the tip 43.

In the case of FIG. 6(B), the light 50 is provided above the thickness direction (in the vertical direction, i.e., up and down directions) of the flat tip 43 of the nozzle 4. The light 50 has a similar configuration as described for light 50 in FIG. 6(A), including a main body portion 51, a supporting portion 52 with a through hole 52a, and a belt 53. The supporting portion 52 is fixed to the tip 43 by winding the belt 53 around the tip 43 of the nozzle 4 through the through hole 52a.

Both the light 50 shown in FIG. 6(A) and FIG. 6(B) are fixed to the nozzle 4, and the direction of the light axis is approximately parallel to the direction of ejection of the blast media from the blast opening 44 of the nozzle 4. With this configuration, during the blast treatment, the part being blasted with the blast media can be illuminated by the light 50, facilitating visual inspection of the removing progress and improving workability. It should be noted that FIGS. 6 (A) and 6(B) illustrate the configuration where the light 50 is attached to the tip 43 of the nozzle 4, but this is not limited to this configuration. For example, it may be attached to the base 41 of the nozzle 4.

Furthermore, the light 50 may have an angle adjustment mechanism provided at the connection between the main body portion 51 and the support portion 52, allowing the light axis of the light 50 to be adjusted as desired. As an angle adjustment mechanism, various types of torque hinges or torque ball joints, which can hold any angle using friction, can be used, for example.

### [Appendix]

The descriptions of the above embodiments disclose the following aspects:

(The Aspect 1)

A surface treatment method for a structure, which removes pollution from an exposed surface of a member of the structure to restore the member, using:
a blast media containing a first grainy material as a main component, where the hardness of the material is equal to or less than the hardness of the member, and
a blast treatment apparatus having a nozzle for blasting the blast media onto the surface of the member using a gas as a driving fluid, a hollow tube for delivering a mixture of the blast media and the gas to the nozzle, and a discharge control unit for adjusting the flow rate of the mixture supplied from the hollow tube to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment adjusting the flow rate of the mixture while the surface of the member is exposed, thereby functioning the mixture blasted from the blast opening forming strip shape as a grinding tool to remove the pollution and forming fine roughness on the surface to be restored, without grinding the underlying or peripheral parts of the surface of the member.

(The Aspect 2)

The surface treatment method defined in the aspect 1, wherein said member is a wooden member, and uses a plant-based blast media with an air-dried specific gravity greater than 0.5 as said first grainy material.

(The Aspect 3)

The surface treatment method defined in the aspect 1 or 2, wherein said member is a painted wooden member of which painted surface is deteriorated, and said blast media contains a second grainy material consisting of either
(A) a plant-based blast media with an air-dried specific gravity of 0.5 or less, or
(B) a mineral-based media, and removes a deteriorated layer on a tightly adhering paint of a paint film on the member as said pollution and exposes a wood grain including the tightly adhering paint underlying the deteriorated layer on the member.

(The Aspect 4)

The surface treatment method defined in any one of the aspects 1 to 4, blasting said mixture onto the surface of the member in a state where the member is incorporated in said structure.

(The Aspect 5)

A surface treatment method for a structure, which removes pollution from an exposed surface of a member of the structure to restore the member, wherein the structure is a manufacturing facility for producing a particulate product that is ingested by an organism,
the member is polluted by a particulate deposit generated during the manufacturing process of the particulate product in the manufacturing facility,
and the surface treatment method using:
a blast media containing a first grainy material as a main component, where the first grainy material is composed of the same substance as the deposit in granular form, and
a blast treatment apparatus having a nozzle for blasting the blast media onto the surface of the member using a gas as a driving fluid, and a hollow tube for delivering a mixture of the blast media and the gas to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment blasting the mixture onto the surface of the member, thereby functioning the mixture blasted from the blast opening forming strip shape as a grinding tool to remove the pollution and forming fine roughness on the surface to be restored, without grinding the underlying or peripheral parts of the surface of the member.

(The Aspect 6)

The surface treatment method defined in the aspect 5, wherein said particulate product is sugar, and said first grainy material is of the blast media is granulated sugar.

(The Aspect 7)

A blast treatment apparatus for surface treatment of a structure, which removes pollution from an exposed surface of a member of the structure to restore the member having:
a media tank for storing a blast media composing a substance with equal or lesser hardness than the member formed in granular form,
a nozzle for blasting the blast media onto the member incorporated in the structure using a driving fluid, and
a light for lighting the member while the blast media is blasted from the nozzle onto the member.

(The Aspect 8)

A deposit removal method for removing a particulate deposit adhered to a manufacturing facility for producing a particulate product, comprising:
blasting a blast media from a nozzle onto a part incorporated in the facility and polluted by the particulate deposit using a granular particle of the same substance as the deposit as the blast media.

(The Aspect 9)

The deposit removal method defined in the aspect 8, wherein said particulate product is sugar, and using sugar with an average particle size ranging from 200 μm to 500 μm and a coefficient of variation ranging from 0.20% to 0.30% or less as the blast media.

(The Aspect 10)

The deposit removal method defined in the aspect 8 or 9, using a flat-shaped nozzle with a first direction and a second direction orthogonal to the first direction, wherein the dimension in the second direction is smaller than the dimension in the first direction as said nozzle, and the dimension in the second direction at the nozzle is 1.6 times or more and 4.0 times or less than the average particle size of said blast media.

(The Aspect 11)

The deposit removal method defined in any one of the aspects 8 to 10, wherein the gas pressure for ejecting said blast media ranges from 0.4 MPa or more to 0.9 or less within a blast media tank for storing the blast media to deliver to the nozzle.

(The Aspect 12)

The deposit removal method defined in the aspect 9, wherein said particulate product is white well-refined sugar, and granulated sugar is used as said blast media.

(The Aspect 13)

The deposit removal method defined in the aspect 8, wherein said particulate product is salt, and said blast media is granular salt.

(The Aspect 14)

A deposit removal apparatus incorporated in a manufacturing facility for producing a particulate product and for removing a particulate deposit adhered to the manufacturing facility, having a nozzle ejecting a blast media, a blast media supply device for supplying granular material of the same substance as the deposit to the nozzle as the blast media, and a measuring device for measuring the ejection condition of the blast media ejected from the nozzle.

(The Aspect 15)

A method for manufacturing a particulate product, comprising:
manufacturing the particulate product while using said deposit removal method defined in any one of the aspects 8 to 13, and removing the particulate deposit adhered to the manufacturing facility for manufacturing the particulate product and having said deposit removal apparatus defined in the aspect 14.

(The Aspect 16)

A particulate product manufacturing facility for manufacturing a particulate product having said deposit removal apparatus defined in the aspect 14.

### INDUSTRIAL APPLICABILITY

The present invention relates to a method and apparatus for removing particulate deposits from manufacturing facility for particulate products. Additionally, it can be suitably applied to particulate product manufacturing methods and facility utilizing the aforementioned method and apparatus.

### REFERENCE CHARACTER LIST

1 Air Blast Treatment Apparatus (Deposit removal Apparatus)
2 Air compressor
3 Blast media tank
4 Blast nozzle
44 Blast opening

1. A surface treatment method for a structure, which removes pollution from an exposed surface of a member of the structure to restore the member, using:
a blast media containing a first grainy material as a main component, where the hardness of the material is equal to or less than the hardness of the member, and
a blast treatment apparatus having a nozzle for blasting the blast media onto the surface of the member using a gas as a driving fluid, a hollow tube for delivering a mixture of the blast media and the gas to the nozzle, and a discharge control unit for adjusting the flow rate of the mixture supplied from the hollow tube to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment adjusting the flow rate of the mixture while the surface of the member is exposed, thereby functioning the mixture blasted from the blast opening forming strip shape as a grinding tool to remove the pollution and forming fine roughness on the surface to be restored, without grinding the underlying or peripheral parts of the surface of the member.

2. The surface treatment method defined in claim 1, wherein said member is a wooden member, and uses a plant-based blast media with an air-dried specific gravity greater than 0.5 as said first grainy material.

3. The surface treatment method defined in claim 2, wherein said member is a painted wooden member of which painted surface is deteriorated, and said blast media contains a second grainy material consisting of either
(A) a plant-based blast media with an air-dried specific gravity of 0.5 or less, or
(B) a mineral-based media, and
removes a deteriorated layer on a tightly adhering paint of a paint film on the member as said pollution and exposes a wood grain including the tightly adhering paint underlying the deteriorated layer on the member.

4. The surface treatment method defined in any one of claims 1 to 4, blasting said mixture onto the surface of the member in a state where the member is incorporated in said structure.

5. A surface treatment method for a structure, which removes pollution from an exposed surface of a member of the structure to restore the member, wherein the structure is a manufacturing facility for producing a particulate product that is ingested by an organism,
the member is polluted by a particulate deposit generated during the manufacturing process of the particulate product in the manufacturing facility,
and the surface treatment method using:
a blast media containing a first grainy material as a main component, where the first grainy material is composed of the same substance as the deposit in granular form, and
a blast treatment apparatus having a nozzle for blasting the blast media onto the surface of the member using a gas as a driving fluid, and a hollow tube for delivering a mixture of the blast media and the gas to the nozzle, wherein the nozzle has a tubular base connected to the hollow tube and a tip extending from the base to an end of the nozzle through an intermediate portion, wherein the end has an approximately rectangular-shaped blast opening with a distance between long sides ranging from 0.5 mm to 1.5 mm,
and the surface treatment method comprising a roughening treatment blasting the mixture onto the surface of the member, thereby functioning the mixture blasted from the blast opening forming strip shape as a grinding tool to remove the pollution and forming fine roughness on the surface to be restored, without grinding the underlying or peripheral parts of the surface of the member.

6. The surface treatment method defined in claim 5, wherein said particulate product is sugar, and said first grainy material is of the blast media is granulated sugar.

7. A blast treatment apparatus for surface treatment of a structure, which removes pollution from an exposed surface of a member of the structure to restore the member having:
a media tank for storing a blast media composing a substance with equal or lesser hardness than the member formed in granular form,
a nozzle for blasting the blast media onto the member incorporated in the structure using a driving fluid, and
a light for lighting the member while the blast media is blasted from the nozzle onto the member.

8. A deposit removal method for removing a particulate deposit adhered to a manufacturing facility for producing a particulate product, comprising:
blasting a blast media from a nozzle onto a part incorporated in the facility and polluted by the particulate deposit using a granular particle of the same substance as the deposit as the blast media.

9. The deposit removal method defined in claim 8, wherein said particulate product is sugar, and using sugar with an average particle size ranging from 200 μm to 500 μm and a coefficient of variation ranging from 0.20% to 0.30% or less as the blast media.

10. The deposit removal method defined in claim 8, using a flat-shaped nozzle with a first direction and a second direction orthogonal to the first direction, wherein the dimension in the second direction is smaller than the dimension in the first direction as said nozzle, and the dimension in the second direction at the nozzle is 1.6 times or more and 4.0 times or less than the average particle size of said blast media.

11. The deposit removal method defined in claim 8, wherein the gas pressure for ejecting said blast media ranges from 0.4 MPa or more to 0.9 or less within a blast media tank for storing the blast media to deliver to the nozzle.

12. The deposit removal method defined in claim 9, wherein said particulate product is white well-refined sugar, and granulated sugar is used as said blast media.

13. The deposit removal method defined in claim 8, wherein said particulate product is salt, and said blast media is granular salt.

14. A deposit removal apparatus incorporated in a manufacturing facility for producing a particulate product and for removing a particulate deposit adhered to the manufacturing facility, having a nozzle ejecting a blast media, a blast media supply device for supplying granular material of the same substance as the deposit to the nozzle as the blast media, and a measuring device for measuring the ejection condition of the blast media ejected from the nozzle.

15. method for manufacturing a particulate product, comprising:
manufacturing the particulate product while using said deposit removal method defined in any one of claims 8 to 13, and removing the particulate deposit adhered to the manufacturing facility for manufacturing the particulate product and having said deposit removal apparatus defined in claim 14.

16. A particulate product manufacturing facility for manufacturing a particulate product having said deposit removal apparatus defined in claim 14.
